(19) United States
(12) Patent Application Publication
(10) Pub. No.: US 2025/0245521 A1
(43) Pub. Date: Jul. 31, 2025

(54) DEVICE AND A METHOD FOR BUILDING A TREE-FORM ARTIFICIAL INTELLIGENCE MODEL

(71) Applicant: SAMSUNG ELECTRONICS CO., LTD., Suwon-si (KR)

(72) Inventors: Srinivas Soumitri MIRIYALA, Visakhapatnam (IN); Praveen Doreswamy NAIDU, Bangalore (IN); Brijraj SINGH, Uttar Pradesh (IN); Mayukh DAS, West Bengal (IN); Venkappa MALA, Bangalore (IN); Sharan Kumar ALLUR, Bangalore (IN)

(73) Assignee: SAMSUNG ELECTRONICS CO., LTD., Suwon-si (KR)

(21) Appl. No.: 19/184,786

(22) Filed: Apr. 21, 2025

Related U.S. Application Data
(63) Continuation of application No. PCT/KR2023/008627, filed on Jun. 21, 2023.

(30) Foreign Application Priority Data
Oct. 21, 2022 (IN) 202241060415
May 2, 2023 (IN) 202241060415

(51) Int. Cl. G06N 3/0985; G06N 3/045

(52) U.S. Cl. CPC G06N 3/0985; G06N 3/045

(57) ABSTRACT

A method, performed by a device, includes identifying data for multiple tasks performed based on different Artificial Intelligence (AI) models; configuring a single tree-form AI model comprising a trunk model and multiple branch models, where each branch model performs a different task; and training the model using datasets for the various tasks. The trunk model performs common operations and is heavier than the branch models. The model architecture and task weightages are determined using Neural Architecture Search to optimize resource usage by decreasing floating-point operations and memory usage in branch models while increasing them in the trunk model to improve overall accuracy. The method supports adding new branch models for new tasks using transfer learning without altering the trunk model. A complementary method involves loading the trunk model into memory, identifying a target task, and loading only the corresponding branch model to efficiently perform the task.

### CROSS-REFERENCE TO RELATED APPLICATION

This application is a by-pass continuation application of International Application No. PCT/KR2023/008627, filed on Jun. 21, 2023, which is based on and claims priority to Indian Provisional Patent Application No. 202241060415, filed on Oct. 21, 2022, in the India Patent Office, and Indian Patent Application No. 202241060415, filed on May 2, 2023, in the India Patent Office, the disclosures of which are incorporated by reference herein in their entireties.

### 1. FIELD

The present disclosure relates to an artificial intelligence (AI) processing method and device, and more particularly, to a method and device for constructing and executing a tree-form AI model configured to perform multiple tasks using a shared trunk model and multiple task-specific branch models in a resource-efficient manner.

### 2. DESCRIPTION OF RELATED ART

As technology for an electronic device develops, consumers are provided with various operations from the electronic device. Each operation may be performed by the electronic device using an artificial intelligence (AI) model. As the operations of electronic devices diversify, multiple AI models are configured to perform tasks. For example, the electronic device provides a detection function for an image using a detection model, and provides a classification operation for the image using a classification model.

In the related art, the number of AI models for various tasks in a mobile phone, such as Computer Vision tasks, is growing rapidly, and each of the AI models is individually and independently trained, tested, quantized, and deployed.

### SUMMARY

According to an aspect of the disclosure, a method, performed by a device, includes identifying data for a plurality of tasks that are performed based on different Artificial Intelligence (AI) models; configuring a single tree-form AI model for the plurality of tasks, wherein the single tree-form AI model includes a trunk model and a plurality of branch models, and each of the plurality of branch models of the single tree-form AI model is configured to perform a different task among the plurality of tasks; and training the single tree-form AI model based on a plurality of datasets for the plurality of tasks, wherein the plurality of datasets comprises a first dataset corresponding to a first task, and a second dataset corresponding to a second task.

The trunk model may be configured to perform a common operation for the plurality of tasks, and the each of the plurality of branch models may be configured to perform an operation for a corresponding task.

The trunk model may be heavier than the each of the plurality of branch models.

The configuring of the single tree-form AI model may comprise: determining, based on a Neural Architecture Search (NAS) method, an architecture of the single tree-form AI model and weightages of the plurality of tasks, wherein the architecture of the single tree-form AI model comprises an architecture of the trunk model and a location on the trunk model where the each of the plurality of branch models is connected.

The architecture of the single tree-form AI model and the weightages of the plurality of tasks may be configured to: decrease floating-point operations (FLOPs) and memory usage of the plurality of branch models; and increase FLOPs and memory usage of the trunk model and a total accuracy for the plurality of tasks.

The training of the single tree-form AI model may comprise: updating a weight of the trunk model, based on the weightages of the plurality of tasks, the plurality of datasets, and gradient descent, and updating a weight of the each of the plurality of branch models, based on a dataset and gradient descent, for a corresponding task, wherein the first dataset and the second dataset differ in at least one of data variety, or data volume.

The method may further comprise: adding a new branch model for a new task to the single tree-form AI model based on a transfer learning method, wherein the trunk model remains unaltered.

According to an aspect of the disclosure, a method, performed by a device, includes loading a trunk model of a single tree-form Artificial Intelligence (AI) model for a plurality of tasks on at least one memory of the device; identifying a target task to be performed among the plurality of tasks; and loading, on the at least one memory, a branch model for the target task among a plurality of branch models of the single tree-form AI model, wherein the single tree-form AI model is trained based on a plurality of datasets for the plurality of tasks, and the plurality of datasets comprises a first dataset corresponding to a first task and a second dataset corresponding to a second task, and wherein each of the plurality of branch models of the single tree-form AI model is configured to perform a different task among the plurality of tasks.

The trunk model may be configured to perform a common operation for the plurality of tasks, and the each of the plurality of branch models may be configured to perform an operation for a corresponding task.

The trunk model may be heavier than the each branch model.

An architecture of the single tree-form AI model and weightages of the plurality of tasks may be determined based on a Neural Architecture Search (NAS) method, and the architecture of the single tree-form AI model may comprise an architecture of the trunk model and a location on the trunk model where the each of the plurality of branch models is connected.

The architecture of the single tree-form AI model and the weightages of the plurality of tasks may be configured to: decrease floating-point operations (FLOPs) and memory usage of the plurality of branch models; and increase FLOPs and memory usage of the trunk model and a total accuracy for the plurality of tasks.

A weight of the trunk model may be updated based on the weightages of the plurality of tasks, the plurality of datasets, and gradient descent, wherein a weight of the each of the plurality of branch models may be updated, based on a dataset and gradient descent, for a corresponding task, and wherein the first dataset and the second dataset differ in at least one of data variety, or data volume.

The tree-form AI model may be added with a new branch model for a new task, based on a transfer learning method, wherein the trunk model remains unaltered.

According to an aspect of the disclosure, a device includes at least one memory storing one or more instructions; at least one processor configured to execute the one or more instructions to: identify data for a plurality of tasks that are performed based on different Artificial Intelligence (AI) models, configure a single tree-form AI model for the plurality of tasks, wherein the single tree-from AI model includes a trunk model and a plurality of branch models, and each of the plurality of branch models of the single tree-form AI model is configured to perform a different task among the plurality of tasks, and training the single tree-form AI model based on a plurality of datasets for the plurality of tasks, wherein the plurality of datasets comprises a first dataset corresponding to a first task and a second dataset corresponding to a second task.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1A is an example diagram illustrating different well-known tasks in Computer Vision, the corresponding AI models and various stages involved in the incorporation of an AI model on the edge device, according to related arts;

FIG. 1B is an example diagram illustrating a pipeline for model-based building and deployment on mobile devices, according to related arts;

FIG. 1C is an example diagram illustrating different functions in a camera application of a mobile phone, according to related arts;

FIG. 1D depicts problems associated with implementation of N AI models in the camera application is depicted in, according to related arts; and

FIG. 2 illustrates a block representation of a device for building a tree-form Artificial Intelligence (AI) model, according to an embodiment of the disclosure;

FIG. 3 illustrates a tree-form AI model, according to an embodiment of the disclosure;

FIG. 4 illustrates an implementation of the optimally designed tree-form AI model in the camera application, according to an embodiment of the disclosure;

FIG. 5 depicts a method for building the tree-form AI model, according to an embodiment of the disclosure;

FIG. 6 illustrates the tree-form DNN model with imbalanced datasets and losses, according to an embodiment of the disclosure;

FIG. 7 illustrates a method indicating a typical Bayesian strategy for fast NAS to obtain optimal tree architecture and task specific weights, according to an embodiment of the disclosure;

FIG. 8 illustrates a block representation of designing the search space corresponding to the method described in FIG. 7, according to an embodiment of the disclosure;

FIG. 9 illustrates a method indicating integration of the NAS to the tree-form DNN, according to an embodiment of the disclosure;

FIG. 10 illustrates on-device implementation for a camera use-case with comparison between existing method and proposed tree-form AI method, according to an embodiment of the disclosure;

FIG. 11 illustrates a new use-case of integrating a new DNN in existing tree, according to an embodiment of the disclosure; and

FIG. 12 illustrates a method to mount a new DNN to the existing tree-form AI model, according to an embodiment of the disclosure.

FIG. 13 illustrates a method performed by a device, for building a single tree-form AI model, according to an embodiment of the disclosure.

FIG. 14 illustrates a method performed by a device, for loading a single tree-form AI model on a working memory of the device to perform a target task, according to an embodiment of the disclosure.

FIG. 15 illustrates a device that builds a single tree-form AI model, according to an embodiment of the disclosure.

FIG. 16 illustrates a device that loads a single tree-form AI model on a working memory of the device to perform a target task, according to an embodiment of the disclosure.

### DETAILED DESCRIPTION

The embodiments described in the disclosure, and the configurations shown in the drawings, are only examples of embodiments, and various modifications may be made without departing from the scope and spirit of the disclosure.

The examples used herein are intended to facilitate an understanding of ways in which the disclosure may be practiced and to further enable those of skill in the art to practice the disclosure. Accordingly, the examples should not be construed as limiting the scope of the disclosure.

The expressions “at least one of A, B and C” and “at least one of A, B, or C”, both indicate “A”, only “B”, only “C”, both “A and B”, both “A and C”, both “B and C”, and all of “A, B, and C”.

In an embodiment of the disclosure, an Artificial Intelligence (AI) model may be trained with various learning methods such as supervised learning, semi-supervised learning, unsupervised learning, reinforcement learning, or transfer learning. In an embodiment of the disclosure, the AI model may be composed of a plurality of neural network layers. Each of the plurality of neural network layers may have a plurality of weight values, and a neural network operation may be performed through an operation between an operation result of a previous layer and a plurality of weight values. A plurality of weights of the plurality of neural network layers may be optimized by a learning result of an AI model. For example, the plurality of weights may be updated so that a loss value or a cost value obtained from the AI model is reduced or minimized during a learning process. The AI model may include a deep neural network, for example, a convolutional neural network (CNN), a long short-term memory (LSTM), and a recurrent neural network (RNN), Restricted Boltzmann Machine (RBM), Deep Belief Network (DBN), Bidirectional Recurrent Deep Neural Network (BRDNN), Transformer, or Deep Q-Networks, but is not limited thereto. The AI model may include a statistical method model, for example, logistic regression, a Gaussian Mixture Model (GMM), a Support Vector Machine (SVM), a Latent Dirichlet Allocation (LDA), or a decision tree, for example., but is not limited thereto. According to an embodiment of the disclosure, the term ‘task’ may be used interchangeably with the term ‘function’. In an embodiment of the disclosure, the term ‘task’ may refer to a function provided by a device or an application. In an embodiment of the disclosure, the term ‘task’ may include operations to be performed for the function. In an embodiment of the disclosure, the term ‘task’ may refer to obtaining/generating/identifying/determining output data based on input data using any AI model. In an example, the task may include an image classification task, an object detection task, a semantic segmentation task, a super resolution task, for example.

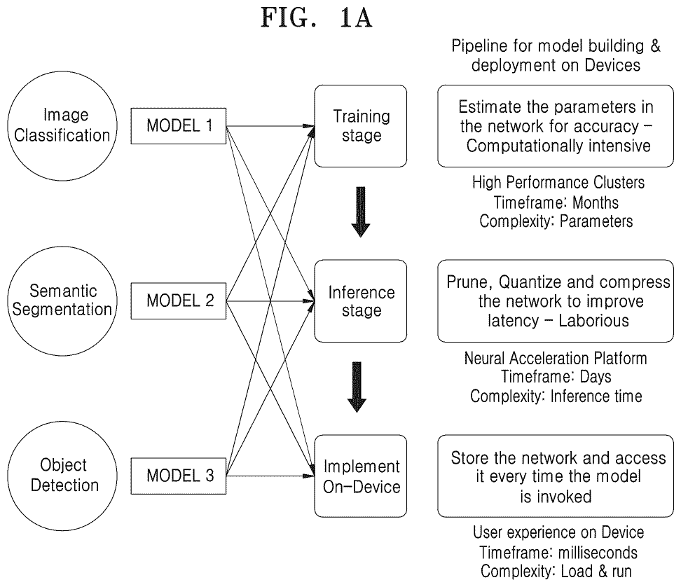

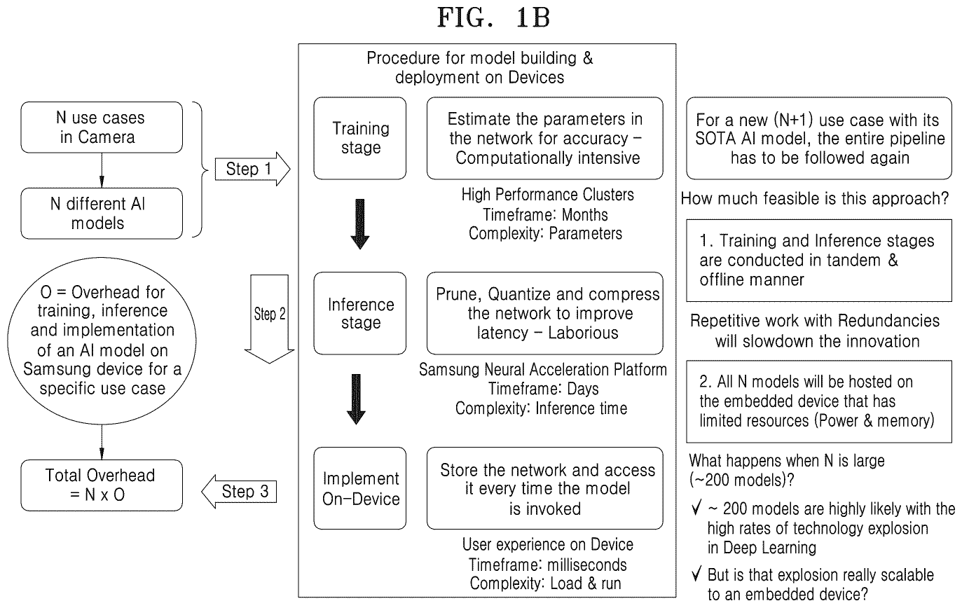

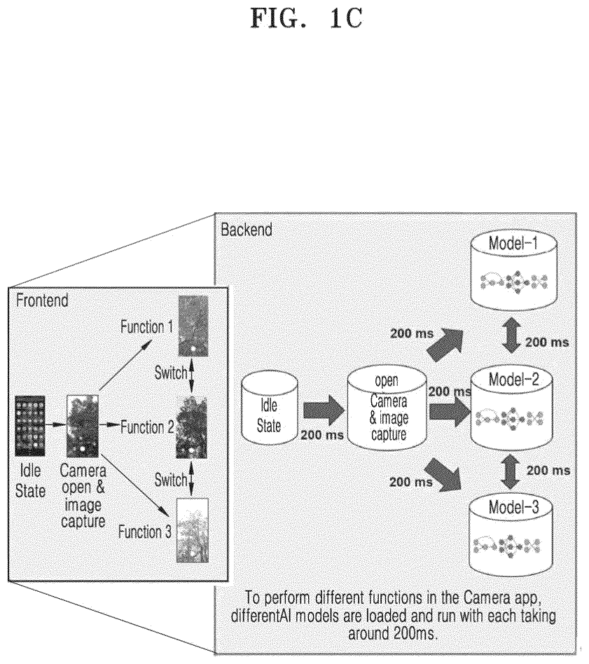

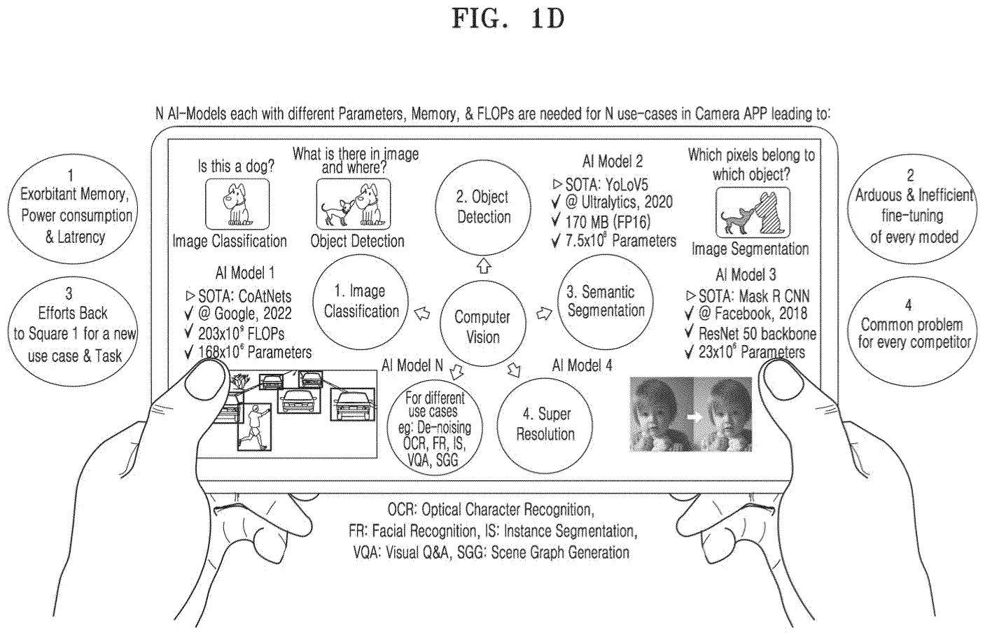

In an embodiment of the disclosure, a novel tree design of a single Deep Neural Network (DNN) that serves multiple deep learning tasks may be provided, enabling fast responsiveness and optimal on-device storage. Referring now to the drawings, and to FIGS. 1 through 16, where similar reference characters denote corresponding features consistently throughout the figures, there are shown embodiments.

FIG. 1A is an example diagram illustrating different well-known tasks, for example in Computer Vision, the corresponding AI models and various stages involved in the incorporation of an AI model on the edge device. The stages may include a training stage, an inference stage, and an implement on-device stage. As illustrated, the training stage may estimate the parameters in the network to maximize the accuracy using computationally intensive methods. Hence, the model may involve high performance clusters with complexity parameters. The inference stage may involve pruning, quantization and compression to improve latency in a laborious way. This stage may involve a complex neural acceleration platform to improve the inference time. The implemented model may be stored on the device and may be accessed every time it is invoked.

FIG. 1B is an example diagram illustrating a pipeline for model-based building and deployment on mobile devices. As illustrated, the output of various stages may result in the overhead (O) associated with training, testing and deploying an AI model. For a new (N+1) use case with its SOTA AI model, the entire pipeline has to be followed again. Thus, Overhead for training, inference and implementation of N AI model on the devices is equal to NXO. For all the N models, training and inference stages may be conducted in tandem and in an offline manner. During the inference stage, all N models will be hosted on the embedded device, which are severely resource constrained. As illustrated, this approach may soon be infeasible when N increases. For example, there may be N=200 AI models for 200 different Computer Vision tasks, deployment of all of N=200 AI models on edge devices may be highly unlikely.

FIG. 1C is an example diagram illustrating different functions in a camera application of a mobile phone. FIG. 1C illustrates the camera application as an example, however other applications in the mobile phone can be considered. As depicted, to perform different functions in the camera application, different AI models are loaded and run with each taking around 200 ms. There are different functionalities which cameras provide on high end devices. Once the camera is activated and the user selects a particular functionality, the entire AI model is loaded. From the memory, the AI model is fetched and loaded. If switching is done from a functionality to other functionality in the same camera application, then the existing AI model is unloaded and again the entire AI model is fetched or a new AI model is loaded from the memory. It is comparatively faster to run an AI model than to fetch it again from the memory.

The problems associated with implementation of N AI models in the camera application is depicted in FIG. 1D. As illustrated in FIG. 1D, the number of AI models involved is as follows: AI model 1 is an image classification model. AI model 2 is an object detection model. AI model 3 is a semantic segmentation model. AI model 4 is a super resolution model. Many more AI models are similarly responsible for different functions in the Camera application. The use of multiple AI models each with different parameters, memory and floating-point operations per second (FLOPs), for multiple use-cases in the camera application may lead to various problems such as: 1. Exorbitant memory, power consumption, and latency; 2. Arduous and inefficient fine-tuning of every AI model; 3. Efforts back to square 1 for a new use case and task; and 4. Common problem for every competitor. Therefore, the edge devices necessitate the integration of N AI models to work together which lead to several challenges described in the FIG. 1C.

Thus, existing systems focus on managing various neural network models during the inference stage. The systems utilize electronic devices for optimizing an AI model. The electronic devices aim at utilizing an AI model for storing the information about every application in advance based on the user's preference and then utilize the same to access the AI model to perform a given user function. The systems do not focus on development or design of the AI models. If there are two AI models A and B for two different use cases, the existing systems focus on identifying similar portion in A and B and then loading the identified portion once instead of twice during the inference stage. The existing systems focus on minimizing the loading time by eliminating redundancies in two or more neural networks. The probability of finding similarities in different neural networks during the inference stage is lesser and is limited to use cases that are analogous. The existing systems cannot scale to new/unseen use cases and rely on designing a new network for every new task.

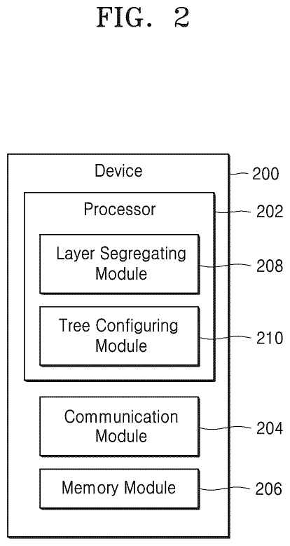

FIG. 2 illustrates a block representation of a device 200 for building a tree-form Artificial Intelligence (AI) model according to an embodiment of the disclosure. In an embodiment of the disclosure, the device 200 is an electronic device. The electronic device may be, but not limited to, a smart phone, a smart watch, a tablet, a desktop, a laptop, a personal digital assistant, a wearable device, and so on. The device 200 may comprise a processor 202, a communication module 204, and a memory module 206.

In an embodiment of the disclosure, the processor 202 may be configured to provide an optimal design and development of AI computational blocks which result in a tree-form structure of a Deep Neural Network (DNN). The designed tree-form structure of the DNN may be capable of performing multiple tasks in various applications, for example, in Computer Vision. The tree-form structure of the DNN may also perform multiple tasks in audio processing, text analysis and so on. This may eliminate the need for multiple AI models during an inference stage. In an embodiment of the disclosure, the processor 202 may comprise a layer segregating module 208 and a tree configuring module 210.

In an embodiment of the disclosure, the layer segregating module 208 may identify one or more layers from a plurality of AI models, for performing a common function. In an embodiment of the disclosure, the layer segregating module 208 may identify one or more layers from the plurality of AI models, for performing specific functions.

In an embodiment of the disclosure, the tree configuring module 210 may configure the identified layers those perform the common function as a trunk portion (e.g., a trunk model) of a tree (for example, a tree-form model). The trunk portion may be configured for performing a function of a heavier AI model. The trunk portion is configured to perform the function heavier than the branches (lightweight AI models). In an embodiment of the disclosure, the trunk portion may be optimally designed using a Neural Architecture Search (NAS) method.

In an embodiment of the disclosure, the tree configuring module 210 may configure the identified layers those perform the specific functions as one or more branches of the tree. The specific functions which are formed into the branches of the tree comprise at least one of classification, segmentation, and detection. The above mentioned functions may be example use cases of computer vision. Other application area such as audio processing, text analysis and so on, with corresponding specific functions may be considered. Each branch may be configured for performing a function of a lightweight AI model. The NAS method, which is utilized to design the trunk portion, may provide one or more optimal locations to attach the branches with the trunk portion of the tree. Thus, a tree-form AI model may be formed with the trunk portion and at least one branch.

In an embodiment of the disclosure, the tree-form AI model may be trained with a plurality of imbalanced datasets originating from a plurality of machine learning tasks. The tree-form AI model may be trained using a cumulative training algorithm by gradient descent. The cumulative training algorithm may consider multiple imbalanced datasets simultaneously for training a common computation block.

In an embodiment of the disclosure, the tree-form AI model may be added with at least one new branch for at least one machine learning task using a transfer learning method. The transfer learning based scalability of the tree-form composite AI model may be implemented to new use-cases/functions/SOTA with minimal additions of AI computational blocks on the existing trunk in terms of a branch.

In an embodiment of the disclosure, the processor 202 may process and execute data of a plurality of modules of the device 200. The processor 202 may be configured to execute instructions stored in the memory module 206. The processor 202 may comprise one or more of microprocessors, circuits, and other hardware configured for processing. The processor 202 may be at least one of a single processer, a plurality of processors, multiple homogeneous or heterogeneous cores, multiple Central Processing Units (CPUs) of different kinds, microcontrollers, special media, and other accelerators. The processor 202 may be an application processor (AP), a graphics-only processing unit such as a graphics processing unit (GPU), a visual processing unit (VPU), and/or an Artificial Intelligence (AI)-dedicated processor such as a neural processing unit (NPU).

In an embodiment of the disclosure, the communication module 204 may be configured to enable communication between the device 200 and a server through a network or cloud, to build a composite AI model. In an embodiment of the disclosure, the server may be configured or programmed to execute instructions of the device 200. In an embodiment of the disclosure, the communication module 204 may enable the device 200 to store images in the network or the cloud, or the server.

In an embodiment of the disclosure, the communication module 204 through which the device 200 and the server communicate may be in the form of either a wired network, a wireless network, or a combination thereof. The wireless communication network may comprise, but not limited to, GPS, GSM, Wi-Fi, Bluetooth low energy, NFC, and so on. The wireless communication may further comprise one or more of Bluetooth, ZigBee, a short-range wireless communication such as UWB, and a medium-range wireless communication such as Wi-Fi or a long-range wireless communication such as 3G/4G/5G/6G and non-3GPP technologies or WiMAX, according to the usage environment.

In an embodiment of the disclosure, the memory module 206 may comprise one or more volatile and non-volatile memory components which are capable of storing data and instructions of the modules of the device 200 to be executed. Examples of the memory module 206 may be, but not limited to, NAND, embedded Multi Media Card (eMMC), Secure Digital (SD) cards, Universal Serial Bus (USB), Serial Advanced Technology Attachment (SATA), solid-state drive (SSD), and so on. The memory module 206 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. The memory module 206 may, in some examples, be considered a non-transitory storage medium. The term “non-transitory” may indicate that the storage medium may be not embodied in a carrier wave or a propagated signal. The term “non-transitory” should not be interpreted to mean that the memory module 206 may be non-movable. In certain examples, a non-transitory storage medium may store data that can, over time, change (e.g., in Random Access Memory (RAM) or cache).

FIG. 2 shows example modules of the device 200 according to an embodiment of the disclosure, but it is to be understood that other embodiments are not limited thereon. In other embodiments, the device 200 may include less or more number of modules. The labels or names of the modules may be used for illustrative purpose and may not limit the scope of the disclosure. One or more modules may be combined together to perform same or substantially similar function in the device 200.

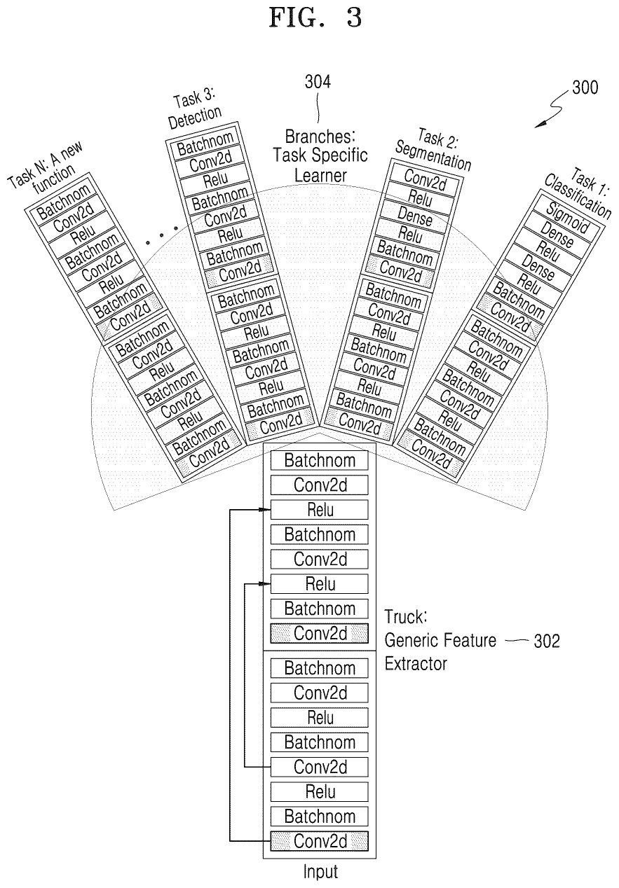

FIG. 3 illustrates a tree-form AI model 300, according to an embodiment of the disclosure. The tree-form AI model 300 may comprise a trunk portion 302 and a plurality of branches (for example, branch models) 304 that are attached to the trunk portion 302. For example, if the tree-form AI model 300 may be implemented in the camera application of a mobile phone, then the trunk portion 302 may be configured to perform a functionality of feature extraction and each branch 304 may be configured to perform a functionality of task specific learning (TSL). The tasks which are functions of the branches may include classification, segmentation, and detection and so on. When a new function may be needed to perform in a mobile application, for example, in the camera application, the corresponding layer of the AI model 300 of that function may be identified by the layer segregating module 208 and be configured in the trunk portion 302 by the tree configuring module 210. The new function may be added as a new branch using a transfer learning method.

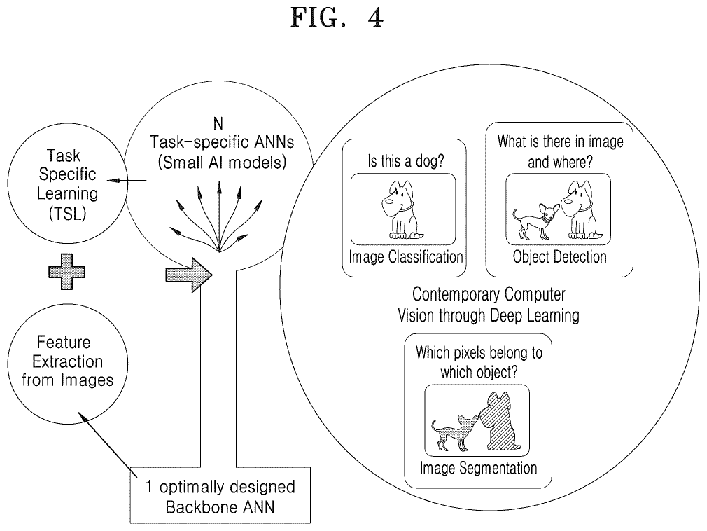

FIG. 4 illustrates an implementation of the optimally designed tree-form AI model in the camera application, according to an embodiment of the disclosure. The tree-form AI model may be implemented as a backbone Artificial Neural Network (ANN) for the camera application. When an image is captured by the mobile phone, the tree-form AI model configured in the camera application may obtain the captured image and extract features from the images. Feature extraction may be common to several vision related use cases. Later, the task specific learning may be implemented to perform specific functions to the extracted features of the image, using the AI models which are configured as branches of the tree. The application of specific functions include, for example such as image classification, object detection and image segmentation thus obtaining a contemporary computer vision through deep learning. The camera application may be considered for this case; however the proposed tree-form AI model may be applied to different applications.

The implementation of the NAS optimized tree-form AI model may enable reduced number of parameters and floating-point operations per second (FLOPs) which implies maximum reduction in power consumption. The tree-form AI model may be easily scalable to future state-of-the-art performance of deep learning (SOTA) with minimal engineering.

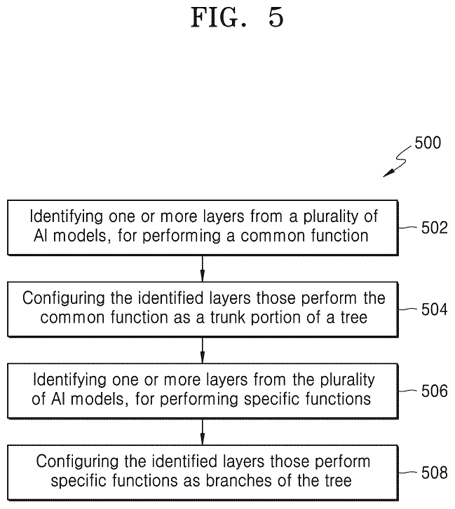

FIG. 5 depicts a method 500 for building the tree-form AI model according to an embodiment of the disclosure. The model 500 may include identifying, by a device 200, one or more layers from a plurality of AI models, for performing a common function, as depicted in operation 502. The method 500 may include configuring, by the device 200, the identified layers those perform the common function as a trunk portion of a tree, as depicted in operation 504. Thereafter, the method 500 may include identifying, by the device 200, one or more layers from the plurality of AI models, for performing specific functions, as depicted in operation 506. The method 500 may include configuring, by the device 200, the identified layers those perform specific functions as branches of the tree, as depicted in operation 508.

The various actions in method 500 may be performed in the order presented, in a different order or simultaneously. In some embodiments, some actions listed in FIG. 5 may be omitted.

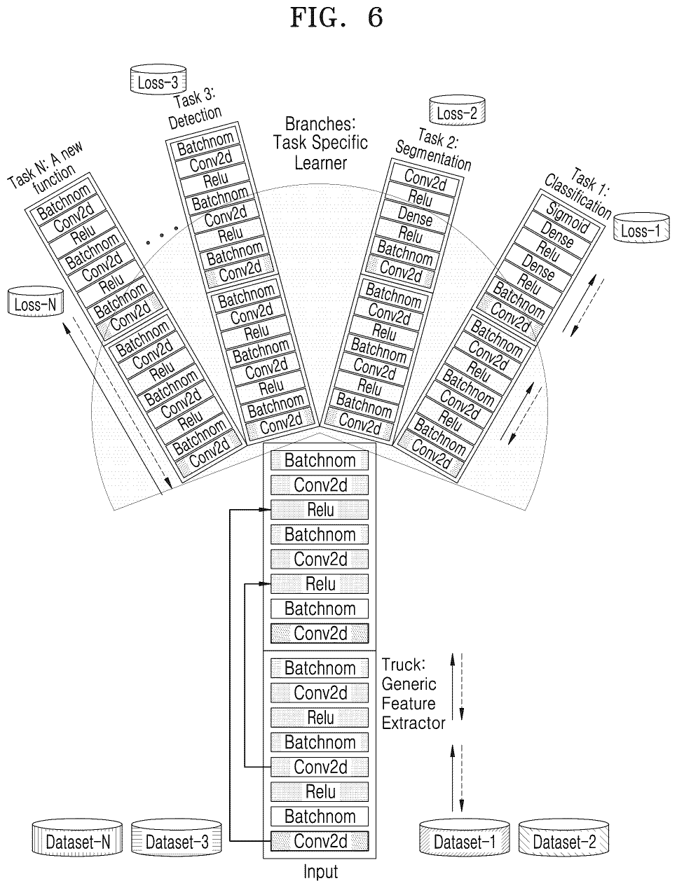

In an embodiment of the disclosure, the cumulative training algorithm for training the tree-form DNN may consider multiple imbalanced datasets simultaneously. FIG. 6 illustrates the tree-form DNN model with imbalanced datasets and losses, according to an embodiment of the disclosure. For each task (^{θ}^{ᵢ}) the losses may be evaluated and the gradients of losses with weights in the trunk portion (W_{T}) and weights in branch i (W_{Bi}) are obtained. Total losses L of the tasks may be given by,

$$L = {θ}_{1} {L}_{1} + {θ}_{2} {L}_{2} + {θ}_{3} {L}_{3} + … + {θ}_{N} {L}_{N}$$

Gradient of loss accumulated in the trunk portion and gradient of loss accumulated in branch for each loss may be given by,

| Gradient of Loss | Gradient of Loss |
|---|---|
| accumulated in Trunk | accumulated in Branch |
| $\frac{\partial {L}_{1}}{\partial {W}_{T}}$ | $\frac{\partial {L}_{1}}{\partial {W}_{B 1}}$ |
| $\frac{\partial {L}_{2}}{\partial {W}_{T}}$ | $\frac{\partial {L}_{2}}{\partial {W}_{B 2}}$ |
| $\frac{\partial {L}_{3}}{\partial {W}_{T}}$ | $\frac{\partial {L}_{3}}{\partial {W}_{B 3}}$ |
| ... | ... |
| $\frac{\partial {L}_{N}}{\partial {W}_{T}}$ | $\frac{\partial {L}_{N}}{\partial {W}_{BN}}$ |

Gradient of loss with weight in the trunk portion may be represented as,

$$\frac{\partial L}{\partial {W}_{T}} = {\sum }_{i = 1}^{N} {θ}_{i} \frac{θ {L}_{i}}{\partial {W}_{T}}$$

W_{T} is optimized using the cumulative loss L.
W_{T}=argmin (L)
Gradient of loss with weight in the branch is represented as,
W_{Bi}=argmin(Lᵢ)∀i=1 to N
W_{Bi} is obtained using the branch loss Li.

For the trained tree-DNN, with fixed architecture & ^{θ}^{ᵢ}, total accuracy, FLOPs and memory of trunk, and FLOPs and memory of branches may be obtained.

Thus, the trunk portion may see/train/consider every dataset while branches deal with specific dataset. Weight (^{θ}^{ᵢ}) on loss from each dataset may allow unbiased presentation of datasets to trunk.

In an embodiment of the disclosure, for simultaneous training of trunk and branches, fixed architecture of the tree may be given as input to the cumulative training algorithm. The fixed architecture of the tree may include number of layers in trunk, number of channels in trunk, number of branches, number of layers in branches, number of channels in branches. Fixed weight on loss ^{θ}^{ᵢ}^{∀i=1 to N}, may be also given as input to the cumulative training algorithm. The fixed weight on loss may decide the weightage to each dataset for training the trunk portion.

The weights in the trunk portion may be updated using cumulative weighted gradient of branch loss, as given below,

$${W}_{T}^{new} = {W}_{T}^{old} - 0.001 \frac{\partial L}{\partial {W}_{T}}$$

The weights in the branch may be updated using gradient of branch loss, as given below,

$${W}_{B i}^{new} = {W}_{B i}^{old} - 0.001 \frac{\partial {L}_{i}}{\partial {W}_{Bi}}$$

Learning of these weights through the NAS in the next step may allow the desired optimal differentiation of datasets by the trunk portion.

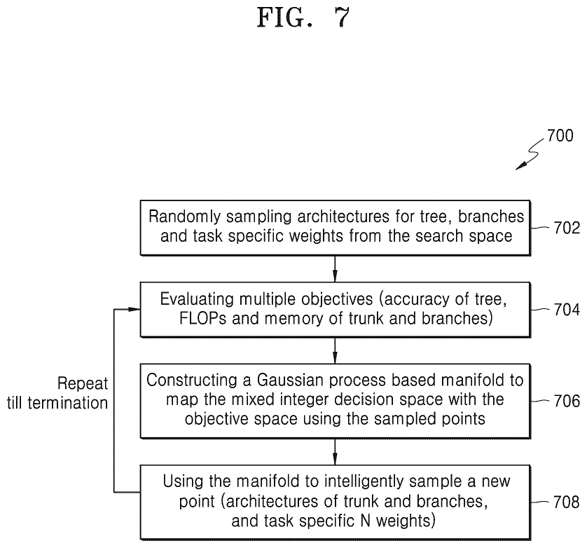

In an embodiment of the disclosure, FIG. 7 illustrates a method 700 indicating a typical Bayesian strategy for fast NAS to obtain optimal tree architecture and task specific weights ^{θ}^{ᵢ} for i=1 to N. The NAS integration may provide designing a search space for optimizing the tree-DNN. The designed search space may be discrete in terms of architectures and real in terms of task specific weights. The designed search space may be a mixed integer search space. The method 700 may include randomly sampling architectures for tree, branches and task specific weights from the search space, as depicting in operation 702. Thereafter, the method 700 may include evaluating multiple objectives such as accuracy of tree, FLOPs and memory of the trunk portion and branches, as depicted in operation 704.

The method 700 may include constructing a Gaussian Process (GP) based manifold to map the mixed integer decision space with the objective space using the sampled points, as depicted in operation 706. The method 700 may include using the manifold to intelligently sample a new point such as architectures of trunk and branches, and task specific N weights, as depicted in operation 708. The method 700 may be repeated from operation 704 till termination of the new point sampling. In an example, the new point may be a new sample toward optima using the GP surrogate.

The various actions in method 700 may be performed in the order presented, in a different order or simultaneously. In some embodiments, some actions listed in FIG. 7 may be omitted.

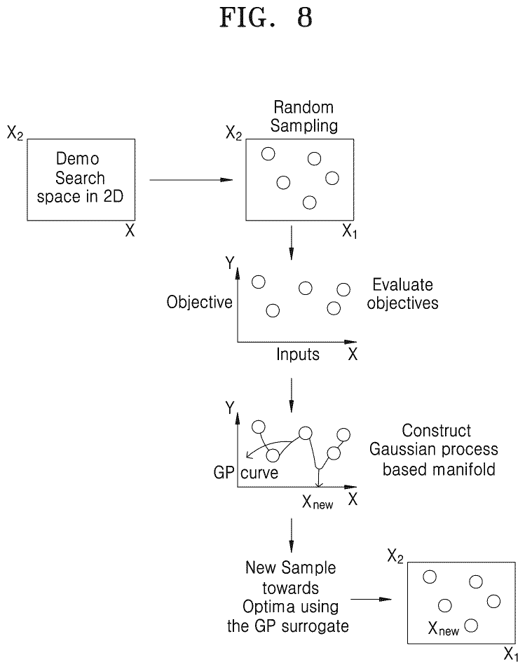

FIG. 8 illustrates a block representation of designing the search space corresponding to the method 700 described in FIG. 7, according to an embodiment of the disclosure.

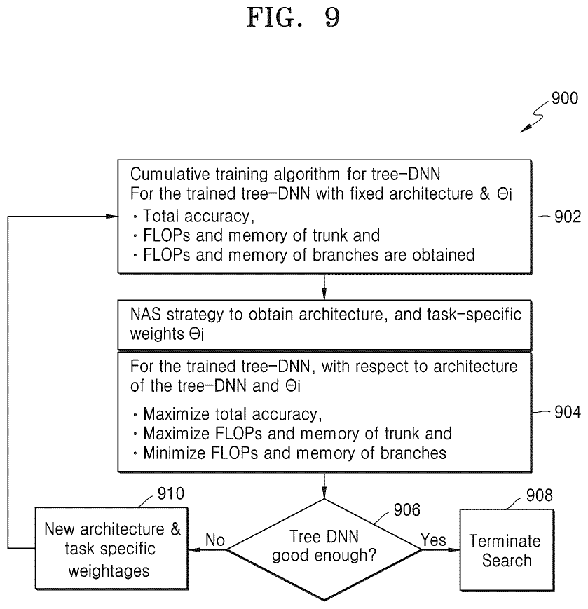

In an embodiment of the disclosure, FIG. 9 illustrates a method 900 indicating integration of the NAS to the tree-form DNN. The integration of the NAS to design the tree-form DNN may be implemented by the Bayesian strategy for fast NAS to obtain optimal tree architecture and task specific weights ^{θ}^{ᵢ} for i=1 to N. The method 900 may include enabling the cumulative training algorithm for the trained tree-DNN with fixed architecture & ^{θ}^{ᵢ}, as depicted in operation 902. The cumulative training algorithm may provide total accuracy, FLOPs and memory of trunk, and FLOPs and memory of branches. The method 900 may include integrating NAS strategy to the trained tree-DNN to obtain architecture and task-specific weights ^{θ}^{ᵢ}, as depicted in operation 904. For the NAS integrated trained tree-DNN, with respect to architecture of the tree-DNN and ^{θ}^{ᵢ}, the total accuracy may be maximized, FLOPs and memory of trunk is maximized, and FLOPs and memory of branches may be minimized. Thereafter, the method 900 may include verifying whether the NAS integrated tree-DNN may be good enough, as depicted in operation 906. If the obtained tree-DNN is efficient enough, then the search for optimizing tree-DNN may be terminated, as depicted in operation 908. If the obtained tree-DNN is not efficient enough, then a new architecture and task specific weightages may be designed, as depicted in operation 910, repeating from operation 902.

The various actions in method 900 may be performed in the order presented, in a different order or simultaneously. In some embodiments, some actions listed in FIG. 9 may be omitted.

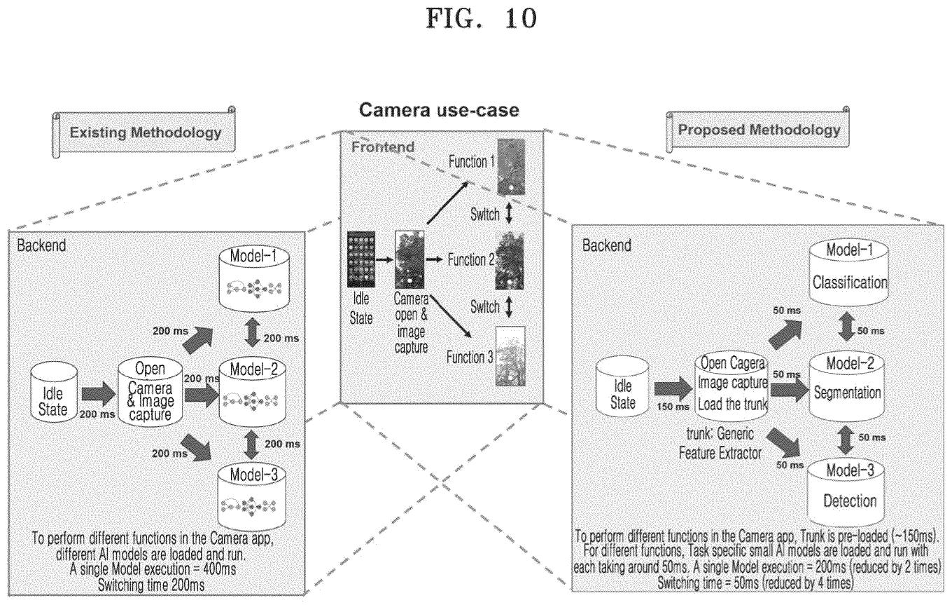

FIG. 10 illustrates on-device implementation for a camera use-case with comparison between existing method and proposed tree-form AI method, according to an embodiment of the disclosure. In a typical scenario of camera use-case, a user may switch modes while using requiring switch between different AI models. In three cameras scenario, the tree-DNN with three branches may be deployed. This way, three different models may be replaced by one tree DNN model. In idle state, the trunk portion of the tree may be kept on the working memory, which can be done as part of pre-processing for making the device ready for the application to be opened next. For every specific camera launch, a branch of the tree may be loaded on working memory, resulting in nearly ˜2x reduction in model loading time and ˜4x reduction in switching time.

Therefore, when compared to existing method, to perform different functions in a mobile application, for example in the camera application, the trunk portion may be pre-loaded (˜150 ms). For different functions, task specific small AI models may be loaded and run with each taking around 50 ms. For example, a single model execution may be equal to 200 ms (reduced by 2 times) and switching time may be equal to 50 ms (reduced by 4 times).

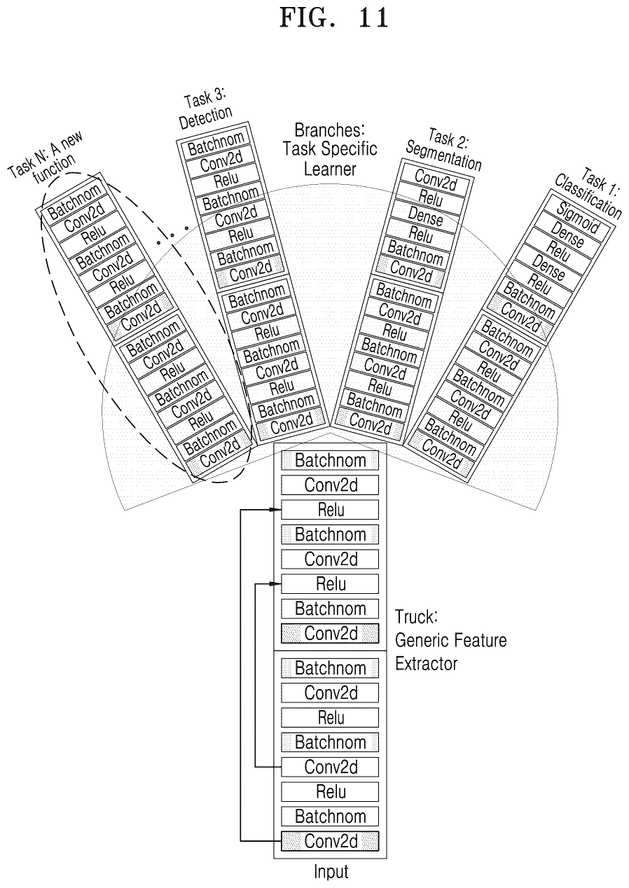

FIG. 11 illustrates a new use-case (for example, Task N: a new function) of integrating a new DNN in existing tree, according to an embodiment of the disclosure.

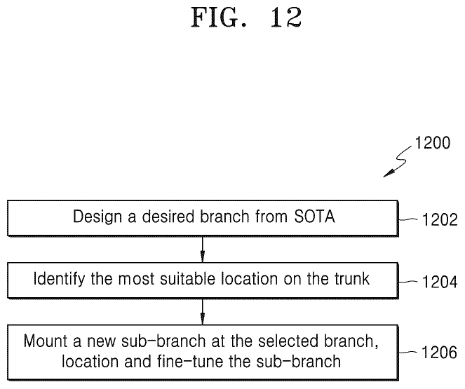

FIG. 12 illustrates a method 1200 to mount a new DNN to the existing tree-form AI model, according to an embodiment of the disclosure. The method 1200 may include designing a desired branch from SOTA, which could work as a possible site to mount the new DNN, as depicted in operation 1202. The method 1200 may include identifying the most suitable location on the trunk, as depicted in operation 1204. The method 1200 may include mounting a new sub-branch at the selected branch, location and fine-tune the new sub-branch for providing specific training without altering the trunk portion or existing tree-DNN, as depicted in operation 1206.

The various actions in method 1200 may be performed in the order presented, in a different order or simultaneously. In some embodiments, some actions listed in FIG. 12 may be omitted.

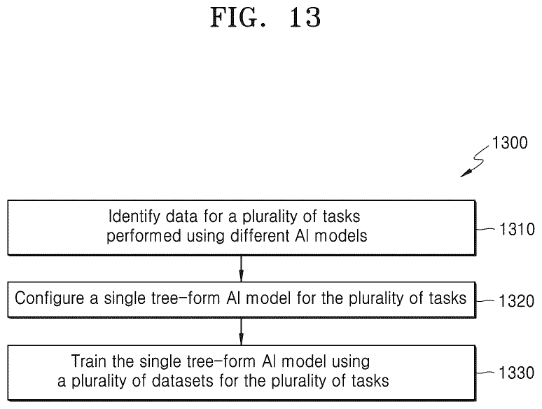

FIG. 13 illustrates a method 1300 performed by a device, for building a single tree-form AI model, according to an embodiment of the disclosure. Referring to FIG. 13, the method 1300 performed by the device (e.g., at least one processor of the device), of building a single tree-form AI model according to an embodiment of the disclosure, may include operations 1310 to 1330. The method 1300 may be not limited to that shown in FIG. 13, and may further include an operation not shown in FIG. 13.

In an operation 1310, the device may identify data for a plurality of tasks performed using different AI models. In an embodiment of the disclosure, the data for the plurality of tasks may include the different AI models for plurality of tasks. For example, the data may include, layers of the different AI models, architectures of the different AI models or parameter values of the different AI models, for example. For example, the data for the plurality of tasks may include a AI model dedicated to each task. In an embodiment of the disclosure, the data for the plurality of tasks may include training dataset for the plurality of tasks, performance (e.g., accuracy, latency) for the plurality of tasks.

In an operation 1320, the device may configure a single tree-form AI model for the plurality of tasks. In an embodiment of the disclosure, the device may configure a single tree-form AI model for the plurality of tasks using Neural Architecture Search (NAS) method (e.g., Bayesian NAS method). In an embodiment of the disclosure, the single tree-form AI model may include a trunk model and a plurality of branch models. In an embodiment of the disclosure, each branch model of the single tree-form AI model may be used for a different task among the plurality of tasks. For example, a fist branch model may be used for a object detection task and a second branch model may be used for a classification task. In an embodiment of the disclosure, the device may configure the single tree-form AI model for the plurality of tasks based on the data for the plurality of tasks. In an example, the device may configure one or more layers of the trunk model and one or more layers of each branch model based on the data for the plurality of tasks.

In an operation 1330, the device may train the single tree-form AI model based on a plurality of datasets for the plurality of tasks including a first dataset corresponding to a first task and a second dataset corresponding to a second task. In an example, the first (or second) dataset corresponding to the first (or second) task may refer to a dataset originated from the first (or second) task, a dataset associated with the first (or second) task, or a training dataset for a AI model for the first (or second) task. In an example, the first (or second) dataset corresponding to the first (or second) task may include at least one of input data or output data of the first (or second) task. In an example, the first (or second) dataset corresponding to the first (or second) task may include at least one of data before the first (or second) task perfomed/processed or data after the first (or second) task perfomed/processed. In an embodiment of the disclosure, the device may update a weight of the trunk model, based on weightages of the plurality of tasks, using the plurality of datasets. In an example, the trunk model is trained based on the plurality of datasets.

In an embodiment of the disclosure, the device may update a weight of the each branch model using a dataset for a task corresponding to the each branch model. For example, a first branch model corresponding to the first task may be trained based on the first dataset for the first task and a second branch model corresponding to the second task may be trained based on the second dataset for the second task.

In an embodiment of the disclosure, the method 1300 may include identifying, by the device, data for a plurality of tasks performed using different AI models. In an embodiment of the disclosure, the method 1300 may include configuring, by the device, a single tree-form AI model for the plurality of tasks. In an embodiment of the disclosure, the method 1300 may include training, by the device, the single tree-form AI model based on a plurality of datasets for the plurality of tasks including a first dataset corresponding to a first task and a second dataset corresponding to a second task.

In an embodiment of the disclosure, the trunk model may be used to perform a common operation for the plurality of tasks. In an embodiment of the disclosure, the each branch model may be used to perform a specific operation for a task corresponding to the each branch model.

In an embodiment of the disclosure, the trunk model may be heavier than the each branch model (e.g., a branch model). In an example, the trunk model may be configured for performing a function of a heavier AI model. In an example, the trunk model may be configured to perform the function heavier than the branch models (lightweight AI models).

In an embodiment of the disclosure, the configuring of the single tree-form AI model may include, determining an architecture of the single tree-form AI model and weightages of the plurality of tasks using the NAS method. In an embodiment of the disclosure, the architecture of the single tree-form AI model may include an architecture of the trunk model and a location of the each branch model on the trunk model (e.g., where each branch model is connected in the trunk).

In an embodiment of the disclosure, the architecture of the single tree-form AI model and the weightages of the plurality of tasks may be determined to decrease floating-point operations (FLOPs) and memory usage of the plurality of branch models and increase FLOPs and memory usage of the trunk model and a total accuracy for the plurality of tasks.

In an embodiment of the disclosure, the training of the single tree-form AI model may include updating a weight of the trunk model, based on the weightages of the plurality of tasks, using the plurality of datasets by gradient descent. In an embodiment of the disclosure, the training of the single tree-form AI model may include updating a weight of the each branch model using a dataset for a task corresponding to the each branch model by gradient descent. In an embodiment of the disclosure, a first dataset and a second dataset may differ in at least one of a variety or a volume of data.

In an embodiment of the disclosure, the method may include adding a new branch model for a new task to the single tree-form AI model using a transfer learning method without altering the trunk model.

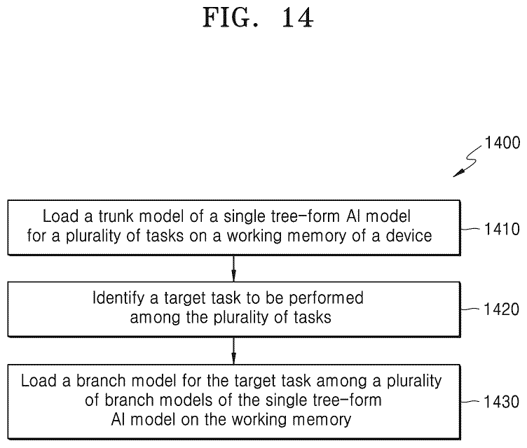

FIG. 14 illustrates a method 1400 performed by a device, for loading a single tree-form AI model on a working memory of the device to perform a target task, according to an embodiment of the disclosure. Referring to FIG. 14, the method 1400 performed by the device (e.g., at least one processor of the device), of loading a single tree-form AI model on a working memory of the device, according to an embodiment of the disclosure, may include operations 1410 to 1430. The method 1400 is not limited to that shown in FIG. 14, and may further include an operation not shown in FIG. 14.

In an operation 1410, the device may load a trunk model of the single tree-form AI model for the plurality of tasks on a working memory of the device. In an embodiment of the disclosure, the device may identify a launch/execution of an application/program associated with the single tree-form AI model. The device may load the trunk model of the single tree-form AI model on the working memory, based on the identifying of the launch/execution of the application/program. In an embodiment of the disclosure, the device may identify input data for the single tree-form AI model. The device may load the trunk model of the single tree-form AI model on the working memory, based on the identifying of the input data. In an example, the device may perform an operation of the trunk model based on the input data.

In an operation 1420, the device may identify the target task to be performed among the plurality of tasks. In an embodiment of the disclosure, the device may identify the target task based on a user input signal. In an example, the device may receive a requests for target task corresponding the user input signal.

In an operation 1430, the device may load a branch model for the target task among a plurality of branch models of the single tree-form AI model on the working memory, based on the identifying of the target task to be performed. In an embodiment of the disclosure, the device may load the branch model for the target task, not load the other branch model. In an embodiment of the disclosure, the device may perform an operation of the branch model for the target task.

In an embodiment of the disclosure, the single tree-form AI model may be configured using a Neural Architecture Search (NAS) method. In an embodiment of the disclosure, the single tree-form AI model may be trained using a plurality of datasets for the plurality of tasks including a first dataset corresponding to a first task and a second dataset corresponding to a second task. In an embodiment of the disclosure, each branch model of the single tree-form AI model may be used for a different task among the plurality of tasks.

In an embodiment of the disclosure, the device may identify a new target task. In an example, the device may identify switching from a first target task to a second target task (for example, a new target task). The device may load a branch model for the new target task on the working memory based on the identifying of the new target task. In an example, The device may perform a operation of the branch model for the new target task.

In an embodiment of the disclosure, the method 1400 may include loading, by the device, a trunk model of a single tree-form AI model for a plurality of tasks on a working memory of the device. In an embodiment of the disclosure, the method 1400 may include identifying, by the device, a target task to be performed among the plurality of tasks, In an embodiment of the disclosure, the method 1400 may include loading, by the device, a branch model for the target task among a plurality of branch models of the single tree-form AI model on the working memory, based on the identifying of the target task to be performed.

In an embodiment of the disclosure, the trunk model may be used to perform a common operation for the plurality of tasks. In an embodiment of the disclosure, the each branch model may be used to perform a specific operation for a task corresponding to the each branch model.

In an embodiment of the disclosure, the trunk model may be heavier than the each branch model. In an embodiment of the disclosure, an architecture of the single tree-form AI model and weightages of the plurality of tasks may be determined using the NAS method. In an embodiment of the disclosure, the architecture of the single tree-form AI model may include an architecture of the trunk model and a location of the each branch model on the trunk model.

In an embodiment of the disclosure, the architecture of the single tree-form AI model and the weightages of the plurality of tasks may be determined to decrease floating-point operations (FLOPs) and memory usage of the plurality of branch models and increase FLOPs and memory usage of the trunk model and a total accuracy for the plurality of tasks.

In an embodiment of the disclosure, a weight of the trunk model may be updated based on the weightages of the plurality of tasks using the plurality of datasets by gradient descent. In an embodiment of the disclosure, a weight of the each branch model may be updated using a dataset for a task corresponding to the each branch model by gradient descent. In an embodiment of the disclosure, a first dataset and a second dataset may differ in at least one of a variety or a volume of data.

In an embodiment of the disclosure, the tree-form AI model may be added with a new branch model for a new task using a transfer learning method without altering the trunk model.

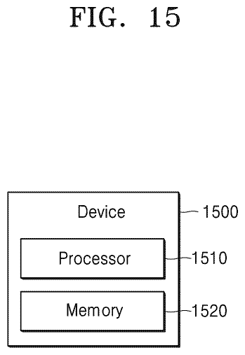

FIG. 15 illustrates a block diagram of a device 1500 according to an embodiment of the disclosure. In an embodiment of the disclosure, the device 1500 is an electronic device, an user equipment, an terminal or server device that builds a single tree-form AI model. In an example, the device 1500 may include at least one of a smart phone, a tablet PC, a mobile phone, a smart watch, a desktop computer, and a laptop computer, notebook, smart glass, navigation device, wearable device, augmented reality (AR) device, virtual reality (VR) device, digital signal transceiver. Referring to FIG. 15, the device 1500 may include at least one processor 1510 and a memory 1520. In an embodiment of the disclosure, the device 1500 is not limited to that illustrated in FIG. 15, and further include a component not illustrated in FIG. 15.

The processor 1510 may be electrically connected to components included in the device 1500 to perform computations or data processing related to control and/or communication of the components included in the device 1500. In an embodiment of the disclosure, the processor 1510 may load a request, a command, or data received from at least one of the other components into the memory 1520 for processing, and store the resultant data in the memory 1520. According to an embodiment of the disclosure, the processor 1510 may include at least one of a central processing unit (CPU), an application processor (AP), a GPU, or a neural processing unit (NPU).

The memory 1520 is electrically connected to the processor 1510 and may store one or more modules, programs, instructions, or data related to operations of components included in the device 1500. The memory 1520 may include at least one type of storage medium, e.g., at least one of a flash memory-type memory, a hard disk-type memory, a multimedia card micro-type memory, a card-type memory (e.g., an SD card or an XD memory), random access memory (RAM), static RAM (SRAM), read-only memory (ROM), electrically erasable programmable ROM (EEPROM), PROM, a magnetic memory, a magnetic disk, or an optical disk.

In an embodiment of the disclosure, the device 1500 may include a memory 1520 storing one or more instructions and at least one processor 1510 configured to execute the one or more instructions stored in the memory. In an embodiment of the disclosure, the at least one processor 1510 may be configured to identify data for a plurality of tasks performed using different AI models. In an embodiment of the disclosure, the at least one processor 1510 may be configured to configure a single tree-form AI model for the plurality of tasks. In an embodiment of the disclosure, the single tree-form AI model may include a trunk model and a plurality of branch models. In an embodiment of the disclosure, each branch model of the single tree-form AI model may be used for a different task among the plurality of tasks. In an embodiment of the disclosure, the at least one processor 1510 may be configured to train the single tree-form AI model using a plurality of datasets for the plurality of tasks including a first dataset corresponding to a first task and a second dataset corresponding to a second task.

In an embodiment of the disclosure, the trunk model may be used to perform a common operation for the plurality of tasks. In an embodiment of the disclosure, the each branch model may be used to perform a specific operation for a task corresponding to the each branch model.

In an embodiment of the disclosure, the trunk model may be heavier than the each branch model. In an embodiment of the disclosure, the at least one processor 1510 may be configured to determine an architecture of the single tree-form AI model and weightages of the plurality of tasks using the NAS method. In an embodiment of the disclosure, the architecture of the single tree-form AI model may include an architecture of the trunk model and a location of the each branch model on the trunk model.

In an embodiment of the disclosure, the architecture of the single tree-form AI model and the weightages of the plurality of tasks may be determined to decrease floating-point operations (FLOPs) and memory usage of the plurality of branch models and increase FLOPs and memory usage of the trunk model and a total accuracy for the plurality of tasks.

In an embodiment of the disclosure, the at least one processor 1510 may be configured to update a weight of the trunk model, based on the weightages of the plurality of tasks, using the plurality of datasets by gradient descent. In an embodiment of the disclosure, the at least one processor 1510 may be configured to update a weight of the each branch model using a dataset for a task corresponding to the each branch model by gradient descent. In an embodiment of the disclosure, a first dataset and a second dataset may differ in at least one of a variety or a volume of data.

In an embodiment of the disclosure, the at least one processor 1510 may be configured to add a new branch model for a new task to the single tree-form AI model using a transfer learning method without altering the trunk model.

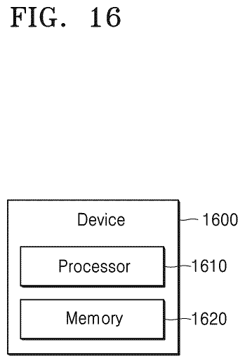

FIG. 16 illustrates a block diagram of a device 1600, according to an embodiment of the disclosure. In an embodiment of the disclosure, the device 1500 is an electronic device, an user equipment, an terminal or server device that loads a single tree-form AI model on a working memory of the device 1500 to perform a target task. In an example, the device 1500 may include at least one of a smart phone, a tablet PC, a mobile phone, a smart watch, a desktop computer, and a laptop computer, notebook, smart glass, navigation device, wearable device, augmented reality (AR) device, virtual reality (VR) device, digital signal transceiver. Referring to FIG. 16, the device 1600 may include at least one processor 1610 and a memory 1620.

The processor 1610 may be electrically connected to components included in the device 1600 to perform computations or data processing related to control and/or communication of the components included in the device 1600. In an embodiment of the disclosure, the processor 1610 may load a request, a command, or data received from at least one of the other components into the memory 1620 for processing, and store the resultant data in the memory 1620. According to an embodiment of the disclosure, the processor 1610 may include at least one of a central processing unit (CPU), an application processor (AP), a GPU, or a neural processing unit (NPU).

The memory 1620 is electrically connected to the processor 1610 and may store one or more modules, programs, instructions, or data related to operations of components included in the device 1600. The memory 1620 may include at least one type of storage medium, e.g., at least one of a flash memory-type memory, a hard disk-type memory, a multimedia card micro-type memory, a card-type memory (e.g., an SD card or an XD memory), random access memory (RAM), static RAM (SRAM), read-only memory (ROM), electrically erasable programmable ROM (EEPROM), PROM, a magnetic memory, a magnetic disk, or an optical disk.

In an embodiment of the disclosure, the device 1600 may include a memory 1620 storing one or more instructions and at least one processor 1610 configured to execute the one or more instructions stored in the memory. In an embodiment of the disclosure, the at least one processor 1610 may be configured to load a trunk model of a single tree-form AI model for a plurality of tasks on a working memory of the device 1600. In an embodiment of the disclosure, the at least one processor 1610 may be configured to identify a target task to be performed among the plurality of tasks. In an embodiment of the disclosure, the at least one processor 1610 may be configured to load a branch model for the target task among a plurality of branch models of the single tree-form AI model on the working memory, based on the identifying of the target task to be performed. In an embodiment of the disclosure, the single tree-form AI model may be configured/formed/generated using a Neural Architecture Search (NAS) method. In an embodiment of the disclosure, the single tree-form AI model may be trained using a plurality of datasets for the plurality of tasks including a first dataset corresponding to a first task and a second dataset corresponding to a second task. In an embodiment of the disclosure, each branch model of the single tree-form AI model may be used for a different task among the plurality of tasks.

In an embodiment of the disclosure, the trunk model may be used to perform a common operation for the plurality of tasks. In an embodiment of the disclosure, the each branch model may be used to perform a specific operation for a task corresponding to the each branch model.

In an embodiment of the disclosure, the trunk model may be heavier than the each branch model. In an embodiment of the disclosure, an architecture of the single tree-form AI model and weightages of the plurality of tasks may be determined using the NAS method. In an embodiment of the disclosure, the architecture of the single tree-form AI model may include an architecture of the trunk model and a location of the each branch model on the trunk model.

In an embodiment of the disclosure, the architecture of the single tree-form AI model and the weightages of the plurality of tasks may be determined to decrease floating-point operations (FLOPs) and memory usage of the plurality of branch models and increase FLOPs and memory usage of the trunk model and a total accuracy for the plurality of tasks.

In an embodiment of the disclosure, a weight of the trunk model may be updated based on the weightages of the plurality of tasks using the plurality of datasets by gradient descent. In an embodiment of the disclosure, a weight of the each branch model may be updated using a dataset for a task corresponding to the each branch model by gradient descent. In an embodiment of the disclosure, a first dataset and a second dataset may differ in at least one of a variety or a volume of data.

In an embodiment of the disclosure, the tree-form AI model may be added with a new branch model for a new task using a transfer learning method without altering the trunk model.

The embodiments described above with reference to any of FIGS. 1 to 16 may also be applied in other figures, and descriptions thereof already provided above may be omitted. Also, the embodiments described with reference to FIGS. 1 to 16 may be combined with one another. In an embodiment of the disclosure, the device 1500 that builds a single tree-form AI model and the device 1600 that performs a target task using a single tree-form AI model may be the same device or different devices.

The embodiments of the disclosure may be implemented through at least one software program running on at least one hardware device. In an embodiment of the disclosure, the device 200 shown in FIG. 2 includes modules which can be at least one of a hardware device, or a combination of hardware device and software module. In an embodiment of the disclosure, the device 1500 shown in FIG. 15 includes modules which can be at least one of a hardware device, or a combination of hardware device and software module. In an embodiment of the disclosure, the device 1600 shown in FIG. 16 includes modules which can be at least one of a hardware device, or a combination of hardware device and software module.

The embodiment of the disclosure describes a system and method for building a tree-form composite AI model. Therefore, it is understood that the scope of the protection is extended to such a program and to a computer readable means having a message therein, such computer readable storage means contain program code means for implementation of one or more operations of the method, when the program runs on a server or mobile device or any suitable programmable device. The method is implemented in at least one embodiment through or together with a software program written in e.g. Very high speed integrated circuit Hardware Description Language (VHDL) another programming language, or implemented by one or more VHDL or several software modules being executed on at least one hardware device. The hardware device may be any kind of portable device that can be programmed. The device may also include means which could be e.g. hardware means like e.g. an ASIC, or a combination of hardware and software means, e.g. an ASIC and an FPGA, or at least one microprocessor and at least one memory with software modules located therein. The method embodiments of the disclosure could be implemented partly in hardware and partly in software. Alternatively, the disclosure may be implemented on different hardware devices, e.g., using a plurality of CPUs.

The foregoing description of the specific embodiments will so fully reveal the nature of the disclosure that others can, by applying current knowledge, readily modify and/or adapt for various applications such specific embodiments without departing from the generic concept, and, therefore, such adaptations and modifications should and are intended to be comprehended within the meaning and range of equivalents of the provided embodiments. It is to be understood that the phraseology or terminology employed herein is for the purpose of description and not of limitation. Therefore, while the disclosure have been described in terms of embodiments and examples, those skilled in the art will recognize that the embodiments and examples provided herein may be practiced with modification within the spirit and scope of the disclosure.

A computer-readable storage medium may be provided in the form of a non-transitory storage medium. In this regard, the term ‘non-transitory’ means that the storage medium does not include a signal and is a tangible device, and the term does not differentiate between where data is semi-permanently stored in the storage medium and where the data is temporarily stored in the storage medium. For example, the ‘non-transitory storage medium’ may include a buffer in which data is temporarily stored.

Furthermore, programs according to embodiments provided in the present specification may be included in a computer program product when provided. The computer program product may be traded, as a product, between a seller and a buyer. For example, the computer program product may be distributed in the form of a computer-readable storage medium (e.g., compact disc ROM (CD-ROM)) or distributed (e.g., downloaded or uploaded) on-line via an application store (e.g., Google Play Store™) or directly between two user devices (e.g., smartphones). For online distribution, at least a part of the computer program product (e.g., a downloadable app) may be at least transiently stored or temporally created on a computer-readable storage medium such as a server of a manufacturer, a server of an application store, or a memory of a relay server.

What is claimed is:

1. A method for processing tasks with an artificial intelligence (AI) model, performed by a device, and the method comprising:
identifying data for a plurality of tasks that are performed based on different AI models;
configuring a single tree-form AI model for the plurality of tasks, wherein the single tree-form AI model includes a trunk model and a plurality of branch models, and each of the plurality of branch models of the single tree-form AI model is configured to perform a different task among the plurality of tasks; and
training the single tree-form AI model based on a plurality of datasets for the plurality of tasks, wherein the plurality of datasets comprises a first dataset corresponding to a first task, and a second dataset corresponding to a second task.

2. The method of claim 1, wherein the trunk model is configured to perform a common operation for the plurality of tasks, and the each of the plurality of branch models is configured to perform an operation for a corresponding task.

3. The method of claim 1, wherein the trunk model is heavier than the each of the plurality of branch models.

4. The method of claim 1, wherein the configuring of the single tree-form AI model comprises:
determining, based on a Neural Architecture Search (NAS) method, an architecture of the single tree-form AI model and weightages of the plurality of tasks,
wherein the architecture of the single tree-form AI model comprises an architecture of the trunk model and a location on the trunk model where the each of the plurality of branch models is connected.

5. The method of claim 4, wherein the architecture of the single tree-form AI model and the weightages of the plurality of tasks are configured to:
decrease floating-point operations (FLOPs) and memory usage of the plurality of branch models; and
increase FLOPs and memory usage of the trunk model and a total accuracy for the plurality of tasks.

6. The method of claim 1, wherein the training of the single tree-form AI model comprises:
updating a weight of the trunk model, based on the weightages of the plurality of tasks, the plurality of datasets, and gradient descent, and
updating a weight of the each of the plurality of branch models, based on a dataset and gradient descent, for a corresponding task,
wherein the first dataset and the second dataset differ in at least one of data variety, or data volume.

7. The method of claim 1, further comprising:
adding a new branch model for a new task to the single tree-form AI model based on a transfer learning method, wherein the trunk model remains unaltered.

8. A method for processing tasks with an artificial intelligence (AI) model, performed by a device, and the method comprising:
loading a trunk model of a single tree-form AI model for a plurality of tasks on at least one memory of the device;
identifying a target task to be performed among the plurality of tasks; and
loading, on the at least one memory, a branch model for the target task among a plurality of branch models of the single tree-form AI model,
wherein the single tree-form AI model is trained based on a plurality of datasets for the plurality of tasks, and the plurality of datasets comprises a first dataset corresponding to a first task and a second dataset corresponding to a second task, and
wherein each of the plurality of branch models of the single tree-form AI model is configured to perform a different task among the plurality of tasks.

9. The method of claim 8, wherein the trunk model is configured to perform a common operation for the plurality of tasks, and the each of the plurality of branch models is configured to perform an operation for a corresponding task.

10. The method of claim 8, wherein the trunk model is heavier than the each branch model.

11. The method of claim 8, wherein an architecture of the single tree-form AI model and weightages of the plurality of tasks are determined based on a Neural Architecture Search (NAS) method, and
wherein the architecture of the single tree-form AI model comprises an architecture of the trunk model and a location on the trunk model where the each of the plurality of branch models is connected.

12. The method of claim 11, wherein the architecture of the single tree-form AI model and the weightages of the plurality of tasks are configured to:
decrease floating-point operations (FLOPs) and memory usage of the plurality of branch models; and
increase FLOPs and memory usage of the trunk model and a total accuracy for the plurality of tasks.

13. The method of claim 11,
wherein a weight of the trunk model is updated based on the weightages of the plurality of tasks, the plurality of datasets, and gradient descent,
wherein a weight of the each of the plurality of branch models is updated, based on a dataset and gradient descent, for a corresponding task, and
wherein the first dataset and the second dataset differ in at least one of data variety, or data volume.

14. The method of claim 8, wherein the tree-form AI model is added with a new branch model for a new task, based on a transfer learning method, wherein the trunk model remains unaltered.

15. A device for processing tasks with an artificial intelligence (AI) model, the device comprising:
at least one memory storing one or more instructions;
at least one processor configured to execute the one or more instructions to:
identify data for a plurality of tasks that are performed based on different AI models,
configure a single tree-form AI model for the plurality of tasks, wherein the single tree-from AI model includes a trunk model and a plurality of branch models, and each of the plurality of branch models of the single tree-form AI model is configured to perform a different task among the plurality of tasks, and
train the single tree-form AI model based on a plurality of datasets for the plurality of tasks, wherein the plurality of datasets comprises a first dataset corresponding to a first task and a second dataset corresponding to a second task.
